(19) United States
(12) Patent Application Publication
(10) Pub. No.: US 2003/0188014 A1
(43) Pub. Date: Oct. 2, 2003

(54) Method for transmiting messages using multipaths

(76) Inventors: Klaus David Gradischnig, Reston, VA (US); Michael Tuxen, Munchen (DE)

Correspondence Address: NEIFELD IP LAW, PC, 2001 JEFFERSON DAVIS HIGHWAY, ARLINGTON, VA, 22202, US

(21) Appl. No.: 10/380,470

(22) PCT Filed: Sep. 17, 2001
(86) PCT No.: PCT/EP01/10747

(30) Foreign Application Priority Data
Sep. 22, 2000 (EP) 00120782.8

(51) Int. Cl. G06F 15/173

(52) U.S. Cl. 709/238; 709/218

(57) ABSTRACT

According to the invention, a connection is routed both via a slow, but broad-band path and via a high-speed, but narrow-band path. The slow path is used for the primary transport of the message. The second path is used for the retransmission requests and/or the retransmissions. There is thus little traffic on this path. The entire connection however has the delay characteristics of the slow path for a faultless transmission.

1. What technical problem is to be solved by your invention?

2. How was this problem solved previously?

3. In what way does your invention solve the specified technical problem (specify advantages)?

4. Exemplary embodiment(s) of the invention.

Re 1.:

Connections with long delays are also used for transmitting messages. If transmission errors occur, a suitable transport protocol must be used to ensure that the incorrectly transmitted message is retransmitted. This considerably increases the transmission time, or just part of the available bandwidth can be used to transmit data, with the rest being used to preclude effects of transmission errors.

Re 2.:

If a connection is used with a communication path, there are two categories of method:

If to this end a retransmission request is required from the recipient, the transmission of a message of this type lasts for approximately three end-to-end delays. The average transmission time thus increases with the error rate. Examples of such methods are Go-Back-N or Multiple Selective Retransmission.

If the sender does not wait for a retransmission request of this type but simply transmits all messages on a multiple basis, the transmission time of incorrect messages is still in the order of the end-to-end delay. However, no more than half the connection capacity can be utilized here. For example, this method is used in the Preventive Cyclic Retransmission method.

Transport protocols (e.g. SCTP, Q.2111-SSCOP-MCE) have recently been developed which use a plurality of communication paths for a connection. However, the data is then, for example in the case of SCTP, repeated if possible on a path other than the first path. However, for example in the case of SCTP, the retransmission request is normally transported back via the path via which the message might have been transported.

In contrast, SSCOPMCE does not stipulate any path selection in the standard.

Re 3.:

According to the invention a connection is routed via a slow (i.e. with a longer delay) but broad-band path and a high-speed but narrow-band path. The slow path is used for the primary data transport. It is thus possible, for example, to use the advantageous price of the higher bandwidth of a path of this type. The second path is high-speed and possibly also more reliable, but it has, for example, less bandwidth for this. This path is used for the retransmission requests and the retransmissions. There is thus little traffic on this path. However, the entire connection has the delay characteristics of the slow path for a faultless transmission. A connection of this type can thus be used for data which copes with the end-to-end delay of the slow path but not with a larger one or the jitter which is caused by retransmissions.

The invention is thus based on the knowledge that multilink protocols can be modified such that they can be used to transparently and significantly improve the transmission characteristics of a connection, in that a second better path is added. However, this is only used in this situation as little as possible and hence gets by with little bandwidth.

Re 4.:

The Stream Control Transmission Protocol (SCTP) is considered as an exemplary embodiment. Two modifications are proposed here:

1. All SCTP datagrams with SACK chunks are sent via the faster link. In this way all desired characteristics are already fulfilled. However, more than is necessary is sent via the high-speed path. For cost reasons it would be desirable to avoid this possibility.

2. All SCTP datagrams with SACK chunks containing gap reports are sent via the high-speed link. The utilized bandwidth of the high-speed path is thus minimized. However, for this a little more functionality is required in the end nodes.

If this method is now implemented by one side, this results in the improvement described here in one direction. Thus it is not essential for both sides to implement this method.

1. Method for message transmission using connections, according to which on the one hand a connection is routed via a slow but broad-band path, and on the other hand via a high-speed but narrow-band path, said slow path being used for the primary message transport and said high-speed path being used for retransmission requests and/or retransmissions.

2. Method according to claim 1
characterized in that
it is applied in a multilink protocol.
